(19) United States
(12) Patent Application Publication
(10) Pub. No.: US 2025/0181105 A1
(43) Pub. Date: Jun. 5, 2025

(54) COMPUTER SYSTEM CONFIGURED TO PERFORM A WAITING DELAY

(71) Applicant: STMicroelectronics International N.V., Geneva (CH)

(72) Inventor: Philippe CHERBONNEL, Betton (FR)

(73) Assignee: STMicroelectronics International N.V., Geneva (CH)

(21) Appl. No.: 18/952,560

(22) Filed: Nov. 19, 2024

(30) Foreign Application Priority Data
Dec. 1, 2023 (FR) 2313465

(51) Int. Cl. G06F 1/04

(52) U.S. Cl. CPC G06F 1/04

(57) ABSTRACT

According to one aspect, provision is made of a timing method implemented by a computer system comprising: a central processing unit, an external clock circuit comprising a counter, the counter being configured to increment or decrement its value with each clock stroke of the external clock circuit over a range of values corresponding to one millisecond, the timing method comprising: defining a maximum number of transitions of a bit to be monitored of the counter value corresponding to a desired waiting delay, monitoring transitions of the bit to be monitored of the counter value so as to achieve the timing until the number of performed transitions of the bit to be monitored reaches the defined maximum number of transitions.

### TECHNICAL FIELD

Embodiments and implementations relate to computer systems, and more particularly to timing of a duration of less than one millisecond by a central processing unit of such a computer system.

### DESCRIPTION OF TECHNOLOGICAL CONTEXT

In certain applications, it is important to provide a solution allowing a central processing unit of a computer system to wait a certain delay during the execution of a computer program.

In particular, a computer system may comprise peripherals that can be accessed by the central processing unit. For example, a computer system peripheral may be an analogue-to-digital converter or an analogue comparator or else a voltage regulator.

These peripherals may have a stabilisation time for intrinsic physical quantities (for example an electrical voltage). The stabilisation time of a peripheral corresponds to a duration required for the peripheral to reach a stable state after a change in conditions or a disturbance, for example during start-up of the peripheral.

When the central processing unit wishes to access a peripheral of the computer system, it is important to provide a waiting delay to allow access to the peripheral after the end of the stabilisation time of this peripheral.

Generally, the stabilisation time is less than one millisecond, in particular of the order of a few microseconds to a few tens of microseconds.

It is known to use software-only solutions to provide a waiting delay in microseconds. In particular, a software loop can be used to cause the central processing unit to wait for a duration corresponding to the waiting delay.

In particular, it is possible to provide an index that can be defined by the following formula:

$$IDX = \frac{D L Y}{10} \times \frac{I\_CLK}{2 \times 100000} + 1 ,$$

where IDX is the index, DLY is the delay in microseconds and I_CLK is a global variable corresponding to the frequency of an internal clock of the central processing unit.

The software loop then comprises a test at the start of the loop to determine if the index value is different from 0.

If the index value is different from 0 then the software loop comprises a decrement of the index.

When the index value reaches 0, then the test at the start of the loop allows to exit the software loop.

Such a software loop then relies only on a global variable corresponding to the frequency of the internal clock of the central processing unit.

The waiting delay obtained by the implementation of such a software loop then has the disadvantage of depending on the compilation of the source code allowing to obtain an assembly code for the software loop.

In particular, the number of instructions to carry out the software loop may vary depending on the compilation carried out. Thus, the waiting delays obtainable from two different compilers can vary significantly.

Such a software-only solution is therefore not precise. It is then generally planned to provide a waiting margin to prevent the waiting delay obtained from being less than the desired waiting delay. This results in wasted time in accessing a peripheral.

Moreover, the computer system may comprise a specific clock circuit configured to manage durations that are multiples of the millisecond (usual order of magnitude for computer system tasks). Such a clock circuit called “Systick” is known in particular, in the ARM Cortex-M architecture. However, such a clock circuit is not suitable alone for managing durations in microseconds of less than one millisecond.

To manage microsecond delays of less than one millisecond, it is possible to use a dedicated clock circuit to count in microseconds. However, such a clock circuit has the disadvantage of monopolising generic resources of the computer system for this specific task.

### BRIEF SUMMARY

There is therefore a need to propose a timing solution allowing to reliably wait for a duration in microseconds of less than 1 millisecond.

According to one aspect, provision is made of a timing method implemented by a computer system comprising:
a central processing unit; and
an external clock circuit comprising a counter, the counter being configured to increment or decrement its value with each clock stroke of the external clock circuit over a range of values corresponding to one millisecond,
   the timing method comprising:
defining by the central processing unit a maximum number of transitions of a bit to be monitored of the counter value, the maximum number of transitions corresponding to a desired waiting delay; and
monitoring by the central processing unit the transitions of the bit to be monitored of the counter value so as to achieve said timing until the number of performed transitions of the bit to be monitored reaches the defined maximum number of transitions.

Such a method allows to wait for a delay of less than one millisecond by monitoring a bit of a counter of an external clock circuit. The waiting delay obtained is then independent of the compiler used to compile the source code.

Such a method thus allows to improve the precision of the waiting delay obtained.

Furthermore, the configuration of the clock circuit remains unchanged, therefore the microsecond waiting solution is non-invasive in the computer system.

In an advantageous implementation, the desired waiting delay corresponds to a stabilisation time of a peripheral of the computer system, said timing being implemented during access of the central processing unit to this peripheral.

Preferably, monitoring the transitions of the bit to be monitored comprises defining a mask allowing to isolate the bit to be monitored when the mask is applied to the value of the counter of the external clock circuit.

Advantageously, the maximum number of transitions of the bit to be monitored is calculated by the formula:

$$IDX = ( ( DLY \times \frac{R L D V}{M S K} ) ≫ 11 ) + 1 ,$$

where IDX is the maximum number of transitions, DLY is the desired delay in microseconds, RLDV is the loading value of the counter CNT of the external clock circuit EXT_CLK corresponding to one millisecond and MSK is the value of the mask of the bit to be monitored.

In an advantageous implementation, said maximum number of transitions is used to initialise an index allowing to count the number of transitions performed by the bit to be monitored of the counter of the external clock circuit.

Advantageously, monitoring the transitions of the bit to be monitored comprises implementing a main loop as long as the value of the index is different from 0, the main loop comprising:
a decrement of the value of the index;
a first secondary loop implemented as long as the value of the bit to be monitored is equal to 0; and
a second secondary loop implemented as long as the value of the bit to be monitored is equal to 1.

According to another aspect, provision is made of a computer system comprising:
a central processing unit;
an external clock circuit comprising a counter, the counter being configured to increment or decrement its value with each clock stroke of the external clock circuit over a range of values corresponding to one millisecond; and
a memory storing a computer program comprising instructions which, when executed by the central processing unit, cause the latter to:
   define a maximum number of transitions of a bit to be monitored of the counter value, the maximum number of transitions corresponding to a desired waiting delay; and
   monitoring transitions of the bit to be monitored of the counter value so as to achieve said timing until the number of performed transitions of the bit to be monitored reaches the defined maximum number of transitions.

In an advantageous embodiment, the computer system further includes a peripheral having a stabilisation time, the computer program comprising instructions which, when executed by the central processing unit, cause the latter to implement said timing during access of the central processing unit to the peripheral, the desired waiting delay of the timing corresponding to the stabilisation time of the peripheral.

Preferably, the computer program comprises instructions which, when executed by the central processing unit, cause the latter to define and apply a mask to the value of the counter of the external clock circuit to isolate the bit to be monitored in order to monitor the transitions of the bit to be monitored.

Advantageously, the computer program comprises instructions which, when executed by the central processing unit, cause the latter to calculate the maximum number of transitions of the bit to be monitored by the formula:

$$IDX = ( ( DLY \times \frac{R L D V}{M S K} ) ≫ 11 ) + 1$$

where IDX is the maximum number of transitions, DLY is the desired delay in microseconds, RLDV is the loading value of the counter CNT of the external clock circuit EXT_CLK corresponding to one millisecond and MSK is the value of the mask of the bit to be monitored.

In an advantageous embodiment, the computer program comprises instructions which, when executed by the central processing unit, cause the latter to use said maximum number of transitions to initialise an index allowing to count the number of transitions performed by the bit to be monitored of the counter of the external clock circuit.

Advantageously, the computer program comprises instructions which, when executed by the central processing unit, cause the latter to monitor transitions of the bit to be monitored by implementing a main loop as long as the value of the index is different from 0, the main loop comprising:
a decrement of the index value;
a first secondary loop implemented as long as the value of the bit to be monitored is equal to 0; and
a second secondary loop implemented as long as the value of the bit to be monitored is equal to 1.

According to another aspect, provision is made of a computer program product comprising instructions which when implemented by a central processing unit of a computer system also including an external clock circuit comprising a counter, the counter being configured to increment or decrement its value with each clock stroke of the external clock circuit over a range of values corresponding to one millisecond, cause the central processing unit to:
define a maximum number of transitions of a bit to be monitored of the counter value, the maximum number of transitions corresponding to a desired waiting delay; and
monitor transitions of the bit to be monitored of the counter value so as to achieve said timing until the number of performed transitions of the bit to be monitored reaches the defined maximum number of transitions.

In an advantageous embodiment, the computer program product comprises instructions which, when executed by the central processing unit, cause the latter to implement said timing during an access of the central processing unit to a peripheral of the computer system, the desired waiting delay of the timing corresponding to a stabilisation time of the peripheral.

### BRIEF DESCRIPTION OF THE SEVERAL VIEWS OF THE DRAWINGS

Other advantages and features of the disclosure will appear upon examining the detailed description of embodiments, which are in no way limiting, and the appended drawings wherein:

FIG. 1,

FIG. 2, and

FIG. 3 illustrate embodiments and implementations of the presently disclosed technology.

### DETAILED DESCRIPTION

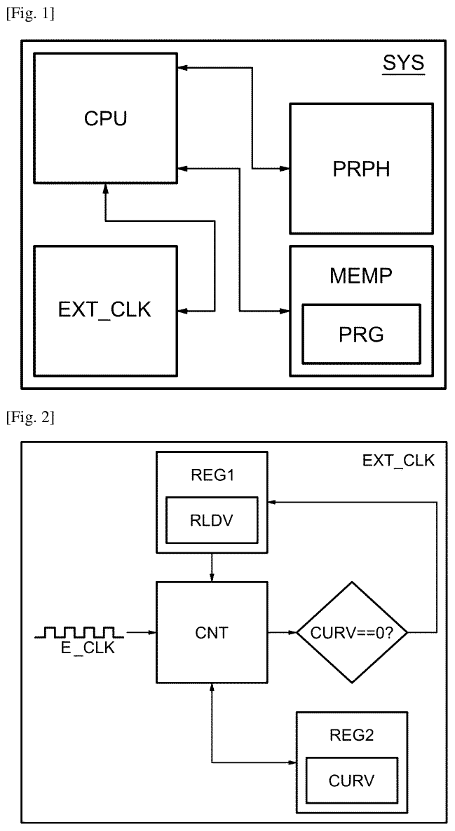

FIG. 1 illustrates a computer system SYS. The computer system SYS comprises a central processing unit CPU, an external clock circuit EXT_CLK, a program memory MEMP and at least one peripheral PRPH.

The peripheral PRPH is an electronic module that can be accessed by the central processing unit CPU. The peripheral PRPH can be an analogue-digital circuit for example.

The peripheral PRPH has a stabilisation time. This stabilisation time corresponds to the time required for the peripheral to reach a stable state after a change in conditions or a disturbance. This stabilisation time is generally indicated in a technical description document relating to this peripheral.

The computer system SYS may have an ARM Cortex-M architecture. In this case, the external clock circuit EXT_CLK can correspond to the clock circuit called “Systick”.

The “Systick” clock circuit is usually used to manage millisecond timings.

FIG. 2 illustrates an embodiment of an external clock circuit EXT_CLK. The external clock circuit EXT_CLK is configured to generate a clock signal E_CLK corresponding to a square periodic signal.

In particular, this clock signal E_CLK can have a frequency comprised between a few hundred kHz (kilohertz) to a few hundred MHz (megahertz), for example of the order of 100 MHz.

The external clock circuit EXT_CLK comprises a first register configured to store a loading value RLDV.

The external clock circuit EXT_CLK also comprises a counter CNT. The counter CNT is configured to decrement its current value CURV with each clock stroke E_CLK.

The initial value of the counter CNT is initialised to the loading value RLDV. The loading value RLDV is selected to match the value that can be reached by the counter in one millisecond. In particular, the loading value RLDV can be determined by the following formula:

$$R L D V = \frac{F\_ECLK}{2 \times F\_CLK} ,$$

where RLDV is the loading value and F_ECLK is the frequency of the clock signal and F_CLK is a clock frequency, typically equal to 1 kHz to obtain a period of 1 millisecond.

When the current value CURV of the counter CNT reaches zero, the counter CNT is configured to resume the loading value RLDV as the current value at the next clock stroke E_CLK.

The external clock circuit EXT_CLK also comprises a second register (in particular the register SYS_CVR in the ARM Cortex-M architecture) configured to store the current value CURV of the counter CNT.

The central processing unit CPU is configured to execute instructions at a frequency of an internal clock (not shown). The frequency of the internal clock can be comprised between a few hundred kHz to a few hundred MHz, for example of the order of 100 MHz.

The central processing unit CPU is configured to be able to access the current value CURV of the counter of the external clock circuit EXT_CLK.

The central processing unit CPU is configured to execute a computer program PRG stored in the program memory MEMP.

The computer program PRG comprises instructions, which when executed by the central processing unit CPU, cause it to access a peripheral.

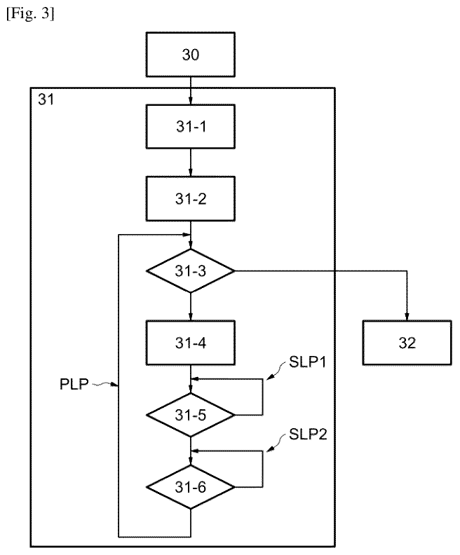

The computer program PRG also comprises instructions, which when executed by the central processing unit CPU, cause the latter to implement a timing method when accessing the peripheral, in particular in order to wait for a delay corresponding to the stabilisation time of this peripheral. FIG. 3 illustrates an implementation of such a timing method.

The computer program PRG also comprises instructions, which when executed by the central processing unit CPU, cause the latter to implement an initialisation function (step 30 of the timing method).

This initialisation function is configured to set the loading value of the external clock circuit EXT_CLK to the value reached by the counter in 1 millisecond.

The computer program PRG also comprises instructions, which when executed by the central processing unit CPU, cause the latter to implement a timing function LL_uDLY allowing to wait for a delay in microseconds of less than one millisecond (step 31 of the timing method).

This function LL_uDLY is in particular implemented before accessing a peripheral PRPH, for example to wait for a stabilisation time of the peripheral PRPH. A C programming language code corresponds to an example of implementation of said function LL_uDLY is illustrated in annex 1.

Said function LL_uDLY is configured to receive as input a desired waiting delay expressed in microseconds. This desired waiting delay corresponds for example to the stabilisation time associated with the peripheral accessed by the central processing unit.

Said function LL_uDLY is configured to use the external clock circuit EXT_CLK to measure said delay in microseconds.

In particular, said function LL_uDLY is configured to monitor a bit of the current value CURV of the counter CNT of the external clock circuit EXT_CLK in order to detect a number of transitions of this bit representative of the delay in microseconds.

The bit to be monitored is chosen according to the frequency of transitions of this bit. In particular, it is important to choose a bit having transitions at a frequency sufficiently lower than the frequency of the internal clock of the central processing unit CPU so that the latter can detect these transitions.

It is also important to choose a bit with transitions at a sufficiently high frequency relative to the desired waiting delay. The bit to be monitored for the current value CURV of the counter CNT can for example be the fourth least significant bit.

In order to allow this monitoring, said function LL_uDLY is configured to define a mask MSK (step 31-1) allowing to isolate the bit to be monitored when the mask MSK is applied to the current value CURV of the counter CNT.

Said function LL_uDLY is also configured to initialise an index IDX (step 31-2) allowing to count the number of transitions performed for the monitored bit. In particular, this index IDX is initialised to a value corresponding to the number of transitions representative of the desired waiting delay in microseconds and is then decremented each time a transition is detected.

Thus, when the index IDX reaches 0 then the expected delay corresponds to the desired waiting delay in microseconds.

This index IDX is stored in a volatile memory (not shown), in particular a RAM (“Random-access memory”) of the central processing unit CPU during the implementation of said function LL_uDLY.

The calculation of the initial value of the index IDX is carried out by the central processing unit CPU during the implementation of said function LL_uDLY.

In particular, the initial value of the index IDX is calculated using the following formula:

$$IDX = ( ( DLY \times \frac{R L D V}{M S K} ) ≫ 11 ) + 1 ,$$

where IDX is the index, DLY is the desired delay in microseconds, RLDV is the loading value of the counter CNT of the external clock circuit EXT_CLK corresponding to one millisecond and MSK is the value of the mask of the bit to be monitored.

Shifting 11 bits to the right is equivalent to a division by 2048 which corresponds to an approximation of a division by 1000 multiplied by 2 (that is to say a division by 2000). This approximation facilitates optimization, as using CPU basic instructions allows lower code size and higher code execution speed.

This offset allows to convert a delay in milliseconds into microseconds, the transitions being performed two by two (for the monitored bit, transition 1 to 0 then transition 0 to 1).

The loading value RLDV corresponding to the value reached by the counter CNT in one millisecond makes it easier to calculate the initial value of the index IDX corresponding to the desired waiting delay.

The function LL_uDLY is then configured to wait for the desired waiting delay by performing a main loop PLP as long as the index value is different from 0.

This main loop PLP allows to perform a monitoring of the transitions of the bit to be monitored and update the index every two transitions detected. Monitoring of the transitions of the bit to be monitored is performed in a loop by the central processing unit CPU.

In particular, the main loop PLP first comprises a test 31-3 of the value of the index in order to determine whether this value is equal to 0.

If the value of the index IDX is different from 0, then the main loop PLP implements operations to monitor the transitions of the bit to be monitored and to update the index.

In particular, the main loop PLP comprises a decrement 31-4 of the index IDX.

The main loop PLP then comprises a first secondary loop SLP1 implemented as long as the value of the bit to be monitored is equal to 0. For this purpose, said first secondary loop SLP1 applies the mask MSK to the current value of the counter of the external clock circuit so as to isolate the value of the bit to be monitored and performs a test 31-5 to determine whether the value obtained by applying the mask MSK is equal to 0.

If the value obtained by applying the mask MSK is equal to 0, then the first secondary loop SLP1 continues to be executed. If the value obtained by applying the mask MSK is different from 0, then the first secondary loop SLP1 is stopped.

The first secondary loop SLP1 thus allows to detect a transition of the monitored bit from 0 to 1.

The main loop PLP then comprises a second secondary loop SLP2 implemented as long as the value of the bit to be monitored is equal to 1. For this purpose, said second secondary loop SLP2 applies the mask MSK to the current value CURV of the counter of the external clock circuit EXT_CLK so as to isolate the value of the bit to be monitored and performs a test 31-6 to determine if the value obtained by applying the mask MSK is different from 0.

If the value obtained by applying the mask MSK is different from 0, then the second secondary loop SLP2 continues to be executed. If the value obtained by applying the mask MSK is equal to 0, then the first secondary loop SLP1 is stopped.

The second secondary loop SLP2 thus allows to detect a transition of the monitored bit from 1 to 0.

Then the main loop PLP is iterated as long as the index value is different from 0.

The main loop PLP is stopped once the index IDX value reaches 0 during the main loop PLP start test (step 32).

Stopping the main loop PLP marks the end of said function LL_uDLY, and therefore the end of the timing.

Such a timing function is thus configured to execute a main loop PLP allowing timing for a duration at least substantially close to the desired waiting delay in microseconds.

This main loop PLP comprises a monitoring of a bit of the counter of the external clock circuit EXT_CLK. In this way, the timed duration does not depend on the cycles of the central processing unit.

Thus, the timed duration does not depend on the compiler or the compilation options selected but is based only on the monitoring of a bit of the counter of the external clock circuit EXT_CLK.

Such a timing function also has the advantage of being precise, particularly when the frequency of the internal clock of the central processing unit CPU is greater than 4 MHz.

A timing method implemented by a computer system (SYS) can include: a central processing unit (CPU); and an external clock circuit (EXT_CLK) including a counter, the counter (CNT) being configured to increment or decrement its value with each clock stroke of the external clock circuit (EXT_CLK) over a range of values corresponding to one millisecond, the timing method including: defining by the central processing unit a maximum number of transitions of a bit to be monitored of the counter value (CNT), the maximum number of transitions corresponding to a desired waiting delay; and monitoring by the central processing unit the transitions of the bit to be monitored of the counter value (CNT) so as to achieve said timing until the number of performed transitions of the bit to be monitored reaches the defined maximum number of transitions.

The desired waiting delay can correspond to a stabilisation time of a peripheral (PRPH) of the computer system (SYS), said timing being implemented during access of the central processing unit (CPU) to this peripheral (PRPH).

Monitoring the transitions of the bit to be monitored can include defining a mask allowing to isolate the bit to be monitored when the mask is applied to the value of the counter (CNT) of the external clock circuit (EXT_CLK).

The maximum number of transitions of the bit to be monitored can be calculated by the formula:

$$IDX = ( ( DLY \times \frac{R L D V}{M S K} ) ≫ 11 ) + 1 ,$$

where IDX is the maximum number of transitions, DLY is the desired delay in microseconds, RLDV is the loading value of the counter CNT of the external clock circuit EXT_CLK corresponding to one millisecond and MSK is the value of the mask of the bit to be monitored.

Said maximum number of transitions can be used to initialise an index allowing to count the number of transitions performed by the bit to be monitored of the counter of the external clock circuit.

Monitoring the transitions of the bit to be monitored can include implementing a main loop (PLP) as long as the value of the index is different from 0, the main loop (PLP) including: a decrement of the index value (IDX); a first secondary loop (SLP1) implemented as long as the value of the bit to be monitored is equal to 0; and a second secondary loop (SLP2) implemented as long as the value of the bit to be monitored is equal to 1.

A computer system can include: a central processing unit (CPU); an external clock circuit (EXT_CLK) including a counter (CNT), the counter (CNT) being configured to increment or decrement its value with each clock stroke of the external clock circuit (EXT_CLK) over a range of values corresponding to one millisecond; and a memory (MEM) storing a computer program (PRG) including instructions which, when executed by the central processing unit (CPU), cause the latter to: define a maximum number of transitions of a bit to be monitored of the counter (CNT) value, the maximum number of transitions corresponding to a desired waiting delay and monitor transitions of the bit to be monitored of the counter (CNT) value so as to achieve said timing until the number of performed transitions of the bit to be monitored reaches the defined maximum number of transitions.

The computer system can further include a peripheral (PRPH) having a stabilisation time, the computer program (PRG) including instructions which, when executed by the central processing unit (CPU), cause the latter to implement said timing during access of the central processing unit (CPU) to the peripheral (PRPH), the desired waiting delay of the timing corresponding to the stabilisation time of the peripheral (PRPH).

The computer program (PRG) can include instructions which, when executed by the central processing unit (CPU), cause the latter to define and apply a mask to the value of the counter (CNT) of the external clock circuit (EXT_CLK) to isolate the bit to be monitored in order to monitor the transitions of the bit to be monitored.

The computer program (PRG) can include instructions which, when executed by the central processing unit (CPU), cause the latter to calculate the maximum number of transitions of the bit to be monitored by the formula:

$$IDX = ( ( DLY \times \frac{R L D V}{M S K} ) ≫ 11 ) + 1 ,$$

where IDX is the maximum number of transitions, DLY is the desired delay in microseconds, RLDV is the loading value of the counter CNT of the external clock circuit EXT_CLK corresponding to one millisecond and MSK is the value of the mask of the bit to be monitored.

The computer program (PRG) can include instructions which, when executed by the central processing unit (CPU), cause the latter to use said maximum number of transitions to initialise an index allowing to count the number of transitions performed by the bit to be monitored of the counter (CNT) of the external clock circuit.

The computer program (PRG) can include instructions which, when executed by the central processing unit (CPU), cause the latter to monitor transitions of the bit to be monitored by implementing a main loop (PLP) as long as the index value is different from 0, the main loop (PLP) including: a decrement of the index value; a first secondary loop (SLP1) implemented as long as the value of the bit to be monitored is equal to 0; and a second secondary loop (SLP2) implemented as long as the value of the bit to be monitored is equal to 1.

A computer program product can include instructions which when implemented by a central processing unit of a computer system also including an external clock circuit (EXT_CLK) including a counter (CNT), the counter (CNT) being configured to increment or decrement its value with each clock stroke of the external clock circuit (EXT_CLK) over a range of values corresponding to one millisecond, cause the central processing unit to: define a maximum number of transitions of a bit to be monitored of the counter value (CNT), the maximum number of transitions corresponding to a desired waiting delay; and monitor transitions of the bit to be monitored of the counter value (CNT) so as to achieve said timing until the number of performed transitions of the bit to be monitored reaches the defined maximum number of transitions.

The computer program product can include instructions which, when executed by the central processing unit (CPU), cause the latter to implement said timing during access of the central processing unit (CPU) to a peripheral (PRPH) of the computer system (SYS), the desired waiting delay of the timing corresponding to a stabilisation time of the peripheral (PRPH).

The computer program product can include instructions which, when executed by the central processing unit (CPU), cause the latter to define and apply a mask to the value of the counter (CNT) of the external clock circuit (EXT_CLK) to isolate the bit to be monitored in order to monitor the transitions of the bit to be monitored.

The computer program product can include instructions which, when executed by the central processing unit (CPU), cause the latter to calculate the maximum number of transitions of the bit to be monitored by the formula:

$$IDX = ( ( DLY \times \frac{R L D V}{M S K} ) ≫ 11 ) + 1 :$$

where IDX is the maximum number of transitions, DLY is the desired delay in microseconds, RLDV is the loading value of the counter CNT of the external clock circuit EXT_CLK corresponding to one millisecond and MSK is the value of the mask of the bit to be monitored.

The computer program product can include instructions which, when executed by the central processing unit (CPU), cause the latter to use said maximum number of transitions to initialise an index allowing to count the number of transitions performed by the bit to be monitored of the counter (CNT) of the external clock circuit.

The computer program product can include instructions which, when executed by the central processing unit (CPU), cause the latter to monitor transitions of the bit to be monitored by implementing a main loop (PLP) as long as the index value is different from 0, the main loop (PLP) including: a decrement of the index value; a first secondary loop (SLP1) implemented as long as the value of the bit to be monitored is equal to 0; and a second secondary loop (SLP2) implemented as long as the value of the bit to be monitored is equal to 1.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. To the extent any of the various patents, applications and publications conflicts with the present disclosure, the present disclosure controls.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### Annex

Example 1 of a C language source code for the timing function LL_uDLY:

void LL_uDLY(uint32_t DLY)
{
uint32_t MSK = (1UL << 4U);
uint32_t IDX = ((DLY * (SysTick−>LOAD / MSK)) >> 11U) + 1U;
while(IDX != 0)
{
IDX−−;
while((SysTick−>VAL & MSK) == 0UL)
{
}
while((SysTick−>VAL & MSK) != 0UL)
{
}
}
}

1. A timing method implemented by a computer system comprising:
a central processing unit, and
an external clock circuit comprising a counter, the counter being configured to increment or decrement a counter value with each clock stroke of the external clock circuit over a range of values corresponding to one millisecond,
the timing method comprising:
defining by the central processing unit a maximum number of transitions of a bit to be monitored of the counter value, the maximum number of transitions corresponding to a desired waiting delay; and
monitoring by the central processing unit the transitions of the bit to be monitored of the counter value to achieve a timing until the number of performed transitions of the bit to be monitored reaches the defined maximum number of transitions.

2. The method according to claim 1, wherein the desired waiting delay corresponds to a stabilisation time of a peripheral of the computer system, the timing being implemented during access of the central processing unit to this peripheral.

3. The method according to claim 1, wherein monitoring the transitions of the bit to be monitored comprises defining a mask allowing to isolate the bit to be monitored when the mask is applied to the counter value of the external clock circuit.

4. The method according to claim 3, wherein the maximum number of transitions of the bit to be monitored is calculated by the formula:
$$IDX = ( ( DLY \times \frac{R L D V}{M S K} ) ≫ 11 ) + 1 ,$$
where IDX is the maximum number of transitions, DLY is the desired delay in microseconds, RLDV is a loading value of the counter of the external clock circuit corresponding to one millisecond, and MSK is the value of the mask of the bit to be monitored.

5. The method according to claim 1, wherein the maximum number of transitions is used to initialise an index allowing to count the number of transitions performed by the bit to be monitored of the counter of the external clock circuit.

6. The method according to claim 5, wherein monitoring the transitions of the bit to be monitored comprises implementing a main loop as long as the value of the index is different from 0, the main loop comprising:
a decrement of the index value;
a first secondary loop implemented as long as the value of the bit to be monitored is equal to 0; and
a second secondary loop implemented as long as the value of the bit to be monitored is equal to 1.

7. A system, comprising:
a central processing unit;
an external clock circuit comprising a counter, the counter being configured to increment or decrement a counter value with each clock stroke of the external clock circuit over a range of values corresponding to one millisecond; and
a memory storing a computer program comprising instructions which, when executed by the central processing unit, cause the system to:
define a maximum number of transitions of a bit to be monitored of the counter value, the maximum number of transitions corresponding to a desired waiting delay and
monitor transitions of the bit to be monitored of the counter value so as to achieve a timing until the number of performed transitions of the bit to be monitored reaches the defined maximum number of transitions.

8. The system according to claim 7, further comprising a peripheral having a stabilisation time, the computer program comprising instructions which, when executed by the central processing unit, cause the system to implement the timing during access of the central processing unit to the peripheral, the desired waiting delay of the timing corresponding to the stabilisation time of the peripheral.

9. The system according to claim 7, wherein the computer program comprises instructions which, when executed by the central processing unit, cause the system to define and apply a mask to the value of the counter of the external clock circuit to isolate the bit to be monitored in order to monitor the transitions of the bit to be monitored.

10. The system according to claim 9, wherein the computer program comprises instructions which, when executed by the central processing unit, cause the system to calculate the maximum number of transitions of the bit to be monitored by the formula:
$$IDX = ( ( DLY \times \frac{R L D V}{M S K} ) ≫ 11 ) + 1 ,$$
where IDX is the maximum number of transitions, DLY is the desired delay in microseconds, RLDV is a loading value of the counter of the external clock circuit corresponding to one millisecond, and MSK is the value of the mask of the bit to be monitored.

11. The system according to claim 7, wherein the computer program comprises instructions which, when executed by the central processing unit, cause the system to use the maximum number of transitions to initialise an index allowing to count the number of transitions performed by the bit to be monitored of the counter of the external clock circuit.

12. The system according to claim 11, wherein the computer program comprises instructions which, when executed by the central processing unit, cause the system to monitor transitions of the bit to be monitored by implementing a main loop as long as the index value is different from 0, the main loop comprising:
a decrement of the index value;
a first secondary loop implemented as long as the value of the bit to be monitored is equal to 0; and
a second secondary loop implemented as long as the value of the bit to be monitored is equal to 1.

13. A computer program product comprising instructions which when implemented by a central processing unit of a system also including an external clock circuit comprising a counter, the counter being configured to increment or decrement a counter value with each clock stroke of the external clock circuit over a range of values corresponding to one millisecond, cause the system to:
define a maximum number of transitions of a bit to be monitored of the counter value, the maximum number of transitions corresponding to a desired waiting delay; and
monitor transitions of the bit to be monitored of the counter value so as to achieve a timing until the number of performed transitions of the bit to be monitored reaches the defined maximum number of transitions.

14. The computer program product according to claim 13, comprising instructions which, when executed by the central processing unit, cause the system to implement the timing during access of the central processing unit to a peripheral of the system, the desired waiting delay of the timing corresponding to a stabilisation time of the peripheral.

15. The computer program product according to claim 13, comprising instructions which, when executed by the central processing unit, cause the system to define and apply a mask to the value of the counter of the external clock circuit to isolate the bit to be monitored in order to monitor the transitions of the bit to be monitored.

16. The computer program product according to claim 15, comprising instructions which, when executed by the central processing unit, cause the system to calculate the maximum number of transitions of the bit to be monitored by the formula:
$$IDX = ( ( DLY \times \frac{R L D V}{M S K} ) ≫ 11 ) + 1 :$$
where IDX is the maximum number of transitions, DLY is the desired delay in microseconds, RLDV is a loading value of the counter of the external clock circuit corresponding to one millisecond, and MSK is the value of the mask of the bit to be monitored.

17. The computer program product according to claim 13, comprising instructions which, when executed by the central processing unit, cause the system to use the maximum number of transitions to initialise an index allowing to count the number of transitions performed by the bit to be monitored of the counter of the external clock circuit.

18. The computer program product according to claim 17, comprising instructions which, when executed by the central processing unit, cause the system to monitor transitions of the bit to be monitored by implementing a main loop as long as the index value is different from 0, the main loop comprising:
a decrement of the index value;
a first secondary loop implemented as long as the value of the bit to be monitored is equal to 0; and
a second secondary loop implemented as long as the value of the bit to be monitored is equal to 1.
